(19) United States
(12) Patent Application Publication
(10) Pub. No.: US 2015/0095840 A1
(43) Pub. Date: Apr. 2, 2015

(54) SMART OPEN POPUP WINDOW

(71) Applicants: Alexey Soshin, Ramat Gan (IL); Vladimir Tkach, Kfar Yona (IL); Rachel Ebner, Ra'anana (IL); Dmitry Khalatov, Yokneam (IL); Eyal Nathan, Reut (IL); Yahali Sherman, Tel Aviv (IL); Ariel Tammam, Ramat Gan (IL)

(72) Inventors: Alexey Soshin, Ramat Gan (IL); Vladimir Tkach, Kfar Yona (IL); Rachel Ebner, Ra'anana (IL); Dmitry Khalatov, Yokneam (IL); Eyal Nathan, Reut (IL); Yahali Sherman, Tel Aviv (IL); Ariel Tammam, Ramat Gan (IL)

(21) Appl. No.: 14/040,932

(22) Filed: Sep. 30, 2013

(51) Int. Cl. G06F 3/0481

(52) U.S. Cl. CPC G06F 3/0481
USPC 715/781

(57) ABSTRACT

Techniques for providing a popup window include identifying a child frame that is displayable in a parent frame, the child frame associated with an application that is executing within the parent frame; identifying a function for providing a popup window; adding the function to the child frame; calling, by the child frame, the function through the parent frame; and in response to the calling, providing for display the popup window in the parent frame.

### TECHNICAL BACKGROUND

This disclosure relates to providing a popup window and, more particularly, providing a popup window within a portal environment.

### BACKGROUND

Business users of software in a business enterprise may access a virtual workspace through a portal to browse, view, modify, and/or otherwise manipulate data related to the business enterprise. Such data may include a variety of information in many different forms, such as sales data, revenue data, human resources information, business hierarchy information, and otherwise. Content objects, such as graphs, tables, charts, electronic communications, web services, reports, applications, and other forms of data, may be viewable in the user's workspace through the portal. The workspace may allow or facilitate the resolution of business issues and/or problems by the user.

### SUMMARY

The present disclosure relates to computer-implemented methods, software, and systems for providing a popup window. In some implementations, a child frame that is displayable in a parent frame is identified. In some examples, the child frame is associated with an application that is executing within the parent frame. A function for providing a popup window is identified. The function is added to the child frame. The function is called by the child frame through the parent frame. In response to the calling, the popup window is provided for display in the parent frame.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, the parent frame is a portal that provides access to the application associated with the child frame to a user.

In a second aspect combinable with any of the previous aspects, the function is an application programming interface (API) for rendering the popup window.

In a third aspect combinable with any of the previous aspects, providing for display further includes providing for display the popup window on a graphical user interface (GUI).

In a fourth aspect combinable with any of the previous aspects, providing for display the popup window further includes obscuring the child frame from display within the GUI by the popup window.

In a fifth aspect combinable with any of the previous aspects, providing for display the popup window further includes preventing obstruction of the child frame from display within the GUI by the popup window.

A sixth aspect combinable with any of the previous aspects further includes identifying one or more additional child frames that are displayable in the parent frame that are contextually associated with the child frame, and providing for display the popup window further includes preventing obstruction of the one or more additional child frames from display within the GUI by the popup window.

A seventh aspect combinable with any of the previous aspects further includes identifying a position on the GUI that a user is gazing, and providing for display the popup window further includes providing for display the popup window at the position within the GUI.

Various implementations of a computing system according to the present disclosure may have one or more of the following features. For example, an application executing within a portal has the option of opening a popup window; the developer does not need to write code to render the popup, and does not need to calculate the popup window's position; if two applications open the same popup window, only one popup window will be rendered, without the applications knowing about each other; and the developer can receive new features seamlessly (e.g., a “remember the last position of the popup window” feature). Further features include that displaying different content pieces on a (portal) page which may very over time, and where the content author does not need to determine manually the location of popup windows from inside the applications/content pieces.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for providing a popup window;

FIG. 2 illustrates an example system for providing a popup window;

FIG. 3 illustrates a graphical user interface including a popup window;

FIG. 4 illustrates a flow chart for providing a popup window;

FIG. 5 illustrates a flow chart for providing for display a popup window; and

FIG. 6 illustrates a flow chart for providing a popup window based on eye-gaze.

### DETAILED DESCRIPTION

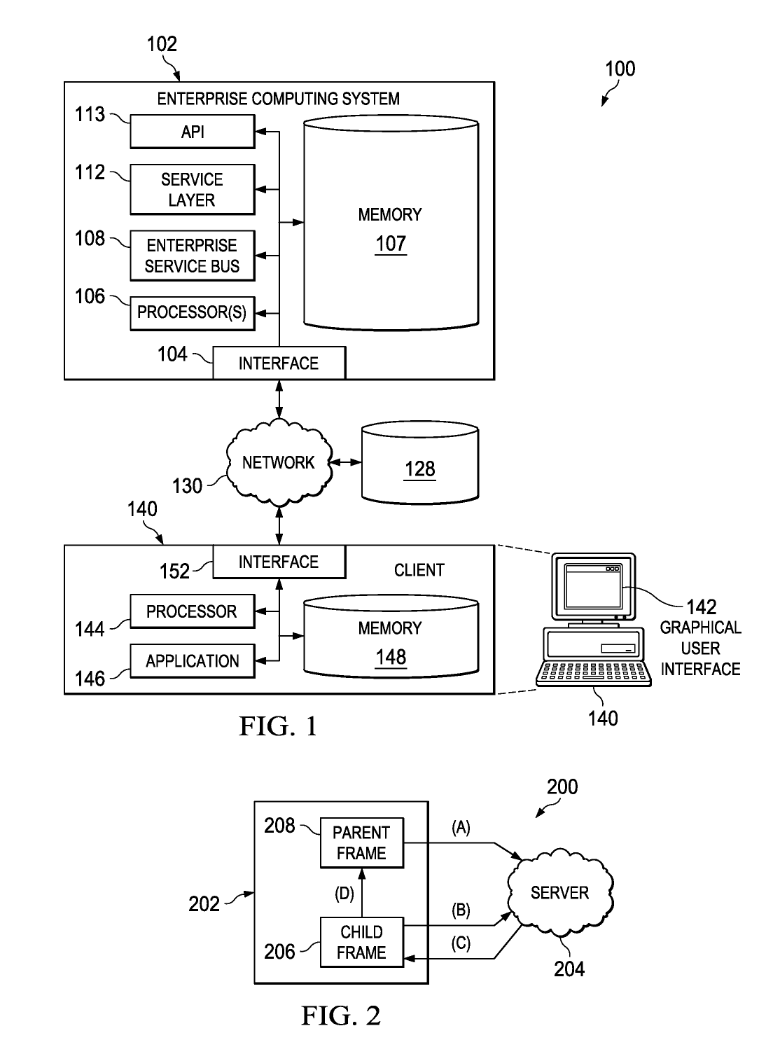

FIG. 1 illustrates an example distributed computing system 100 for providing a popup window. In some implementations, a child frame that is displayable in a parent frame is identified. In some examples, the child frame is associated with an application that is executing within the parent frame. A function for providing a popup window is identified and added to the child frame. The function is called by the child frame through the parent frame, and in response to the calling, the popup window is provided for display in the parent frame.

In some examples, the illustrated enterprise server computing system 102 may store a plurality of various hosted applications, while in some examples, the enterprise server computing system 102 may be a dedicated server meant to store and execute only a single hosted application. In some instances, the enterprise server computing system 102 may comprise a web server, where the hosted applications represent one or more web-based applications accessed and executed via the network 130 by the client computing system 140 to perform the programmed tasks or operations of the hosted application. In some examples, the enterprise server computing system 102 includes information (reference) to applications that are executing from another server.

At a high level, the illustrated enterprise server computing system 102 comprises an electronic computing device operable to receive, transmit, process, store, or manage data and information associated with the distributed computing system 100. Specifically, the enterprise server computing system 102 illustrated in FIG. 1 is responsible for receiving application requests from one or more client applications associated with the client computing system 140 of the distributed computing system 100 and responding to the received requests by processing said requests in the associated hosted application, and sending the appropriate response from the hosted application back to the requesting client application. In addition to requests from the client computing system 140 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise server computing system 102, the distributed computing system 100 can be implemented using two or more servers, as well as computers other than servers, including a server pool. In some examples, the enterprise server computing system 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the enterprise server computing system 102 may be adapted to execute any operating system, including Linux, UNIX, Windows, Mac OS, or any other suitable operating system.

The illustrated enterprise server computing system 102 further includes an interface 104. Although illustrated as a single interface 104 in FIG. 1, two or more interfaces 104 may be used according to particular needs, desires, or particular implementations of the example distributed computing system 100. The interface 104 is used by the enterprise server computing system 102 for communicating with other systems in a distributed environment—including within the example distributed computing system 100—connected to the network 130; for example, the client computing system 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, ABAP, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The illustrated enterprise server computing system 102 further includes a processor 106. Although illustrated as a single processor 106 in FIG. 1, two or more processors may be used according to particular needs, desires, or particular implementations of the example distributed computing system 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise server computing system 102. Specifically, the processor 106 executes the functionality that may be required to receive and respond to requests from the client computing system 140.

The illustrated enterprise server computing system 102 also includes a memory 107. Although illustrated as a single memory 107 in FIG. 1, two or more memories may be used according to particular needs, desires, or particular implementations of the example distributed computing system 100. While memory 107 is illustrated as an integral component of the enterprise server computing system 102, in some implementations, the memory 107 can be external to the enterprise server computing system 102 and/or the example distributed computing system 100. The memory 107 may include any memory or database module and may take the form of volatile or non-volatile memory including, without limitation, magnetic media, optical media, random access memory (RAM), read-only memory (ROM), removable media, or any other suitable local or remote memory component. The memory 107 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise computing system 102. Additionally, the memory 107 may include any other appropriate data, such as VPN applications, firmware logs and policies, firewall policies, a security or access log, print or other reporting files, as well as others.

The illustrated enterprise server computing system 102 further includes a service layer 112. The service layer 112 provides software services to the example distributed computing system 100. The functionality of the enterprise server computing system 102 may be accessible for all service consumers using this service layer. For example, in one implementation, the client computing system 140 can utilize the service layer 112 to communicate with the design engine 118. Software services provide reusable, defined business functionalities through a defined interface. For example, the interface may be software written in extensible markup language (XML) or other suitable language. While illustrated as an integrated component of the enterprise server computing system 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The illustrated enterprise server computing system 102 further includes an application programming interface (API) 113. In some implementations, the API 113 can be used to interface between the design engine 118 and one or more components of the enterprise server computing system 102 or other components of the example distributed computing system 100, both hardware and software. For example, in some implementations, the design engine 118 can utilize the API 113 to communicate with the client computing system 140. The API 113 may include specifications for routines, data structures, and object classes. The API 113 may be either computer language independent or dependent and refer to a complete interface, a single function, or even a set of APIs. While illustrated as an integrated component of the enterprise server computing system 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client computing system 140 may be any computing device operable to connect to or communicate with at least the enterprise server computing system 102 using the network 130. In general, the client computing system 140 comprises a computer operable to receive, transmit, process, and store any appropriate data associated with the example distributed computing system 100. The illustrated client computing system 140 further includes an application 146. The application 146 is any type of application that allows the client computing system 140 to request and view content on the client computing system 140. In some implementations, the application 146 can be and/or include a web browser. In some implementations, the application 146 can use parameters, metadata, and other information received at launch to access a particular set of data from the enterprise server computing system 102. Once a particular application 146 is launched, a user may interactively process a task, event, or other information associated with the enterprise server computing system 102. Further, although illustrated as a single application 146, the application 146 may be implemented as multiple applications in the client computing system 140.

The illustrated client computing system 140 further includes an interface 152, a processor 144, and a memory 148. The interface 152 is used by the client computing system 140 for communicating with other systems in a distributed environment—including within the example distributed computing system 100—connected to the network 130; for example, the enterprise server computing system 102 as well as other systems communicably coupled to the network 130 (not illustrated). The interface 152 may also be consistent with the above-described interface 104 of the enterprise server computing system 102 or other interfaces within the example distributed computing system 100.

The processor 144 may be consistent with the above-described processor 106 of the enterprise server computing system 102 or other processors within the example distributed computing system 100. Specifically, the processor 144 executes instructions and manipulates data to perform the operations of the client computing system 140, including the functionality required to send requests to the enterprise server computing system 102 and to receive and process responses from the enterprise server computing system 102. The memory 148 may be consistent with the above-described memory 107 of the enterprise server computing system 102 or other memories within the example distributed computing system 100 but storing objects and/or data associated with the purposes of the client computing system 140.

Further, the illustrated client computing system 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server computing system 102. Generally, through the GUI 142, an enterprise server computing system 102 user is provided with an efficient and user-friendly presentation of data provided by or communicated within the example distributed computing system 100.

There may be any number of client computing systems 140 associated with, or external to, the example distributed computing system 100. For example, while the illustrated example distributed computing system 100 includes one client computing system 140 communicably coupled to the enterprise server computing system 102 using network 130, alternative implementations of the example distributed computing system 100 may include any number of client computing systems 140 suitable for the purposes of the example distributed computing system 100. Additionally, there may also be one or more client computing systems 140 external to the illustrated portion of the example distributed computing system 100 that are capable of interacting with the example distributed computing system 100 using the network 130. Moreover, while the client computing system 140 is described in terms of being used by a single user, this disclosure contemplates that many users may use one computer, or that one user may use multiple computers.

The illustrated client computing system 140 is intended to encompass any computing device such as a desktop computer, laptop/notebook computer, wireless data port, smart phone, personal data assistant (PDA), tablet computing device, one or more processors within these devices, or any other suitable processing device. For example, the client computing system 140 may comprise a computer that includes an input device, such as a keypad, touch screen, or other device that can accept user information, and an output device that conveys information associated with the operation of the enterprise server computing system 102 or the client computing system 140 itself, including digital data, visual information, or a GUI 142, as shown with respect to the client computing system 140.

The illustrated distributed computing system 100 further includes a repository 128. In some implementations, the repository 128 is an in-memory repository. The repository 128 can be a cloud-based storage medium. For example, the repository 128 can be networked online storage where data is stored on virtualized pools of storage.

With respect to the network 130, generally, the illustrated network 130 facilitates wireless or wireline communications between the components of the distributed computing system 100 (i.e., between the computing systems 102 and 140), as well as with any other local or remote computer, such as additional clients, servers, or other devices communicably coupled to network 130 but not illustrated in FIG. 1. The network 130 is illustrated as a single network in FIG. 1, but may be a continuous or discontinuous network without departing from the scope of this disclosure, so long as at least a portion of the network 130 may facilitate communications between senders and recipients. The network 130 may be all or a portion of an enterprise or secured network, while in another instance at least a portion of the network 130 may represent a connection to the Internet.

In some instances, a portion of the network 130 may be a virtual private network (VPN), such as, for example, the connection between the client computing system 140 and the enterprise server computing system 102. Further, all or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated distributed computing system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

FIG. 2 illustrates an example system 200 for providing a popup window. Specifically, system 200 includes a client computing system 202 and a server computing system 204. In some examples, the client computing system 202 is similar to the client computing system 140 and the server computing system 204 is similar to the enterprise computing system 102.

In some implementations, a child frame is identified that is displayable in a parent frame. For example, the client computing system 202 includes a child frame 206 and a parent frame 208. The child frame 206 is displayable within the parent frame 208 (e.g., the parent frame 208 is a container for the child frame 206). In some examples, the child frame 206 is included by the parent frame 208. In some examples, the child frame 206 and the parent frame 208 are iFrames within a HTML environment (or a XML environment).

In some examples, the child frame 206 is associated with an application that is executing within the parent frame 208. For example, the child frame 206 (e.g., an application) points to a file (e.g., a XML file) on the server computing system 204. The server computing system 204 parses the file (e.g., the XML file) and returns a JavaScript file that the child frame 206 is able to execute (e.g., the content of the child frame 206).

In some examples, the parent frame 208 includes two or more child frames (e.g., nine child frames). In some examples, one or more of the child frames are isolated from the remaining child frames. In some examples, one or more of the child frames cannot access (e.g., communicate) with the remaining child frames. In some examples, the parent frame 208 and the child frame 206 are implemented in the OpenSocial computing platform (architecture). For example, in the OpenSocial computing platform, the child frame 206 are associated with an application that executes from a remote server and proxied through the enterprise server (e.g., the enterprise server computing system 102).

In some examples, the parent frame 208 is a portal that provides access to the application that is associated with the child frame 206 to a user (e.g., a user interacting with the parent frame 208). For example, the portal can include an enterprise portal, also known as an enterprise information portal (EIP) or corporate portal. The portal may be a framework for integrating information, people and processes across organizational boundaries. The portal provides a secure unified access point, often in the form of a web-based user interface, and is designed to aggregate and personalize information through application-specific portlets. For example, the web portal may exhibit de-centralized content contribution and content management, which keeps the information always updated. With only a web browser, users can begin work once they have been authenticated in the portal which offers a single point of access to information, enterprise applications, and services both inside and outside an organization. Enterprise portals may present information from diverse sources in a unified way, and provide additional services, such as an internal search engine, e-mail, news, and various other features. Enterprise portals are often used by enterprises for providing their employees, customers, and possibly additional users with a consistent look and feel, and access control and procedures for multiple applications, which otherwise would have been separate entities altogether.

In some implementations, a function is identified that provides a popup window. For example, during operation (A), the parent frame 208 provides the function to the server computing system 204 (e.g., over a network). In some examples, the parent frame 208 declares the function. The server computing system 204 can store the function (e.g., in memory).

In some examples, the function is an application programming interface (API) for providing for display (e.g., rendering) the popup window, described further below. For example, the function includes computer-programming language (e.g., code) that provides for display a popup window. In some examples, the function can include HTML or XML code.

During operation (B), the child frame 206 provides a request to the server computing system 204 (e.g., over a network) for the function.

In some implementations, the function is added to the child frame. For example, during operation (C), the server computing system 204 provides the function to the child frame 206 (e.g., by communication over a network with the client computing system 202). The child frame 206 receives the function. Specifically, in some examples, the function (e.g., the computer-programming language of the function) is added to the child frame 206 (e.g., added or appended to the computer-programming language of the child frame 206). In some examples, the parent frame 208 adds (or injects) the code associated with the function to the child frame 206. In some examples, the server computing system 204 adds (or injects) the code associated witht efunction to the child frame 206 before it is sent of the client computing system 202.

In some implementations, the function is called by the child frame through the parent frame. For example, during operation (D), the child frame 206 calls the function (e.g., the popup function) through the parent frame 208. In some examples, calling of the function by the child frame 206 can include communicating with the parent frame 208 by remote procedure calls (RPC). In some examples, RPC works by communication between the child frame 206 and the parent frame 208 using the client computing system 202 capabilities (serves the browser provides). In some examples, RPC may work by sending messages between the child frame 206 and the parent frame 208 though the server computing system 204.

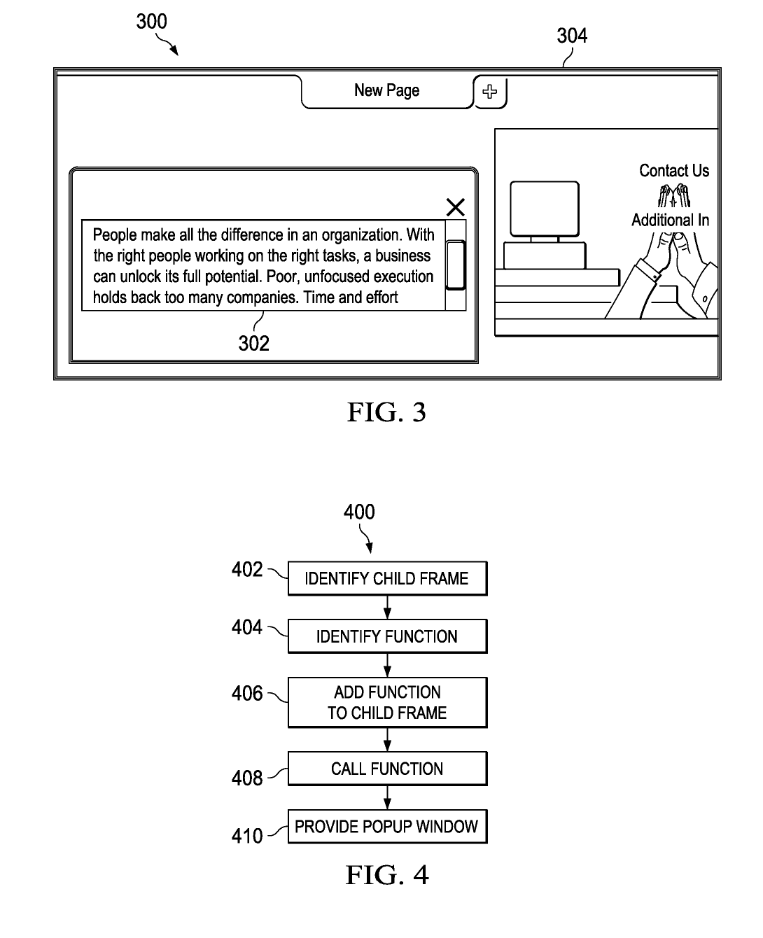

In some implementations, in response to the child frame calling the function, the popup window is provided for display within the parent frame. For example, the function provides for the display, upon being called by the child frame 206, the popup window within the parent frame 208. In some examples, providing for display the popup window (e.g., by the function) includes providing for display the popup window on a graphical user interface (GUI), e.g., the GUI 142 of the client computing device 140. For example, referring to FIG. 3, a GUI 300 is illustrated (e.g., similar to that of GUI 142) including a popup window 302. The popup window 302 is displayed within the GUI 300, and more specifically, within a parent frame 304 of the GUI 300.

In some examples, providing for display the popup window further includes obscuring the child frame 206 from display within the GUI by the popup window. For example, obscuring the child frame 206 from display within the GUI includes the popup window being displayed “over” the child frame 206. That is, the popup window is displayed in the foreground of the GUI and the child frame 206 is displayed in the background of the GUI. In other words, the popup window occupies screen real estate (e.g., pixel area) of the GUI that was previously occupied by the child frame 206. Thus, the child frame 206 is obscured from view (e.g., as viewed by the user) by the popup window.

In some examples, providing for display the popup window further includes preventing obstruction of the child frame 206 from display within the GUI by the popup window. For example, preventing obstruction of the child frame 206 from display within the GUI includes the popup window being displayed at position on the GUI that differs from the displayed position of the child frame 206. For example, the popup window is displayed in the GUI adjacent, or proximate, to the child frame 206. In other words, the popup window occupies screen real estate (e.g., pixel area) of the GUI that differs from the screen real estate (e.g., pixel area) occupied by the child frame 206. Thus, the child frame 206 is prevented from being obscured from view (e.g., as viewed by the user) by the popup window.

In some examples, one or more additional child frames are identified that are displayable in the parent frame 208 that are contextually associated with the child frame 206. For example, the additional child frames and the child frame 206 can include similar subject matter (e.g., relate to a similar technology field); associated with the same role of a user interacting with the frames (e.g., a “manager” role); associated with the same tags (e.g., metadata); or other possible similarities.

In some examples, providing for display the popup window further includes preventing obstruction of the additional child frames from display within the GUI by the popup window. For example, preventing obstruction of the additional child frames from display within the GUI includes the popup window being displayed at position on the GUI that differs from the displayed position of the additional child frames. For example, the popup window is displayed in the GUI adjacent, or proximate, to the additional child frames. In other words, the popup window occupies screen real estate (e.g., pixel area) of the GUI that differs from the screen real estate (e.g., pixel area) occupied by the additional child frames. Thus, the additional child frames are prevented from being obscured from view (e.g., as viewed by the user) by the popup window.

In some examples, the additional child frames are ranked based on a similarity to the child frame 206. For example, the additional child frames that are more similar to the child frame 206 are ranked higher. To that end, in some examples, the popup window can obscure one or more of the additional child frames based on a rank of the additional child frames. That is, the additional child frames having a lower rank are obstructed from display within the GUI by the popup window as compared to the additional child frames having a higher rank.

In some implementations, providing for display the popup window further includes providing the display the popup window within the child frame 206. For example, the popup window is contained within (e.g., graphically) the child frame 206.

In some implementations, a position on the GUI that the user is gazing is identified. For example, the user is gazing (e.g., looking) at a specific position on the GUI (e.g., a specific area of pixels of the GUI). For example, the user is looking at the top right quadrant of the GUI. The position on the GUI that the user is gazing can be identified by any gazing-detecting means, including utilizing a camera-sensing system, or a heads-up displaying system. To that end, providing for display the popup window further includes providing for display the popup window at the position within the GUI that was identified that the user was gazing at. For example, the user is gazing at the top right quadrant of the GUI and the popup window is positioned at the top right quadrant of the GUI.

FIG. 4 illustrates a flow chart that illustrates a method for providing a popup window. For clarity of presentation, the description that follows generally describes method 400 in the context of FIGS. 1 and 2. For example, as illustrated, particular steps of the method 400 may be performed on or at an enterprise system, cloud-based system, and/or on-demand system, while other particular steps may be performed on or at a client system or on a server system (either on-premise or cloud based system). However, method 400 may be performed, for example, by any other suitable system, environment, software, and hardware, or a combination of systems, environments, software, and hardware as appropriate.

At step 402, a child frame that is displayable in a parent frame is identified. In some examples, the child frame is associated with an application that is executing within the parent frame. In some examples, the parent frame is a portal that provides access to the application associated with the child frame to a user. At step 404, a function for providing a popup window is identified. In some examples, the function is an application programming interface (API) for rendering the popup window. At step 406, the function is added to the child frame. At step 408, the function is called by the child frame through the parent frame. At step 410, in response to the calling, the popup window is provided for display in the parent frame.

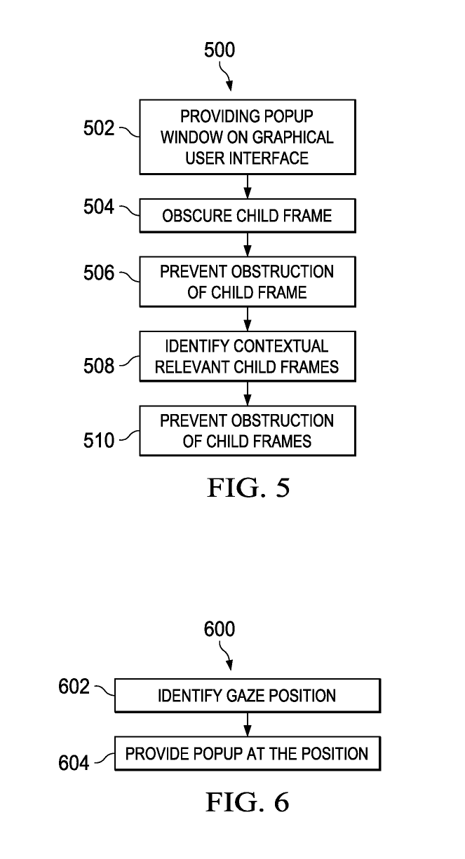

FIG. 5 illustrates a flow chart that illustrates a method for providing for display a popup window. For clarity of presentation, the description that follows generally describes method 500 in the context of FIGS. 1 and 2. For example, as illustrated, particular steps of the method 500 may be performed on or at an enterprise system, cloud-based system, and/or on-demand system, while other particular steps may be performed on or at a client system or on-premise system. However, method 500 may be performed, for example, by any other suitable system, environment, software, and hardware, or a combination of systems, environments, software, and hardware as appropriate. Operations of method 500 can include one or more optional steps, including only one or more of the steps being performed, and further, that the steps of FIG. 5 can be performed in any order.

At step 502, the popup window is provided for display on a graphical user interface (GUI). At step 504, the child frame is obscured from display within the GUI by the popup window. At step 506, obstruction of the child frame is prevented from display within the GUI by the popup window. At step 508, one or more additional child frames are identified that are contextually associated with the child frame are displayable in the parent frame. At step 510, obstruction of the one or more additional child frames is prevented from display within the GUI by the popup window.

FIG. 6 illustrates a flow chart that illustrates a method for providing a popup window based on eye-gaze. For clarity of presentation, the description that follows generally describes method 600 in the context of FIGS. 1 and 2. For example, as illustrated, particular steps of the method 600 may be performed on or at an enterprise system, cloud-based system, and/or on-demand system, while other particular steps may be performed on or at a client system or on-premise system. However, method 600 may be performed, for example, by any other suitable system, environment, software, and hardware, or a combination of systems, environments, software, and hardware as appropriate.

At step 602, a position on the GUI that a user is gazing is identified. At step 604, the popup window is provided for display at the position within the GUI.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIGS. 4-6), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Accordingly, the above description of example implementations does not define or constrain this disclosure. Other changes, substitutions, and alterations are also possible without departing from the spirit and scope of this disclosure.

What is claimed is:

1. A computer-implemented method for providing a popup window, the method comprising:
identifying a child frame that is displayable in a parent frame, the child frame associated with an application that is executing within the parent frame;
identifying a function for providing a popup window;
adding the function to the child frame;
calling, by the child frame, the function through the parent frame; and
in response to the calling, providing for display the popup window in the parent frame.

2. The computer-implemented method of claim 1, wherein the parent frame is a portal that provides access to the application associated with the child frame to a user.

3. The computer-implemented method of claim 1, wherein the function is an application programming interface (API) for rendering the popup window.

4. The computer-implemented method of claim 1, wherein providing for display further comprises providing for display the popup window on a graphical user interface (GUI).

5. The computer-implemented method of claim 4, wherein providing for display the popup window further comprises obscuring the child frame from display within the GUI by the popup window.

6. The computer-implemented method of claim 4, wherein providing for display the popup window further comprises preventing obstruction of the child frame from display within the GUI by the popup window.

7. The computer-implemented method of claim 4, the method further comprising:
identifying one or more additional child frames that are displayable in the parent frame that are contextually associated with the child frame,
wherein providing for display the popup window further comprises preventing obstruction of the one or more additional child frames from display within the GUI by the popup window.

8. The computer-implemented method of claim 1, further comprising:
identifying a position on the GUI that a user is gazing,
wherein providing for display the popup window further comprising providing for display the popup window at the position within the GUI.

9. A computer storage medium encoded with a computer program, the program comprising instructions that when executed by one or more computers cause the one or more computers to perform operations comprising:
identifying a child frame that is displayable in a parent frame, the child frame associated with an application that is executing within the parent frame;
identifying a function for providing a popup window;
adding the function to the child frame;
calling, by the child frame, the function through the parent frame; and
in response to the calling, providing for display the popup window in the parent frame.

10. The computer storage medium of claim 9, wherein the parent frame is a portal that provides access to the application associated with the child frame to a user.

11. The computer storage medium of claim 9, wherein the function is an application programming interface (API) for rendering the popup window.

12. The computer storage medium of claim 9, wherein providing for display further comprises providing for display the popup window on a graphical user interface (GUI).

13. The computer storage medium of claim 12, wherein providing for display the popup window further comprises obscuring the child frame from display within the GUI by the popup window.

14. The computer storage medium of claim 12, wherein providing for display the popup window further comprises preventing obstruction of the child frame from display within the GUI by the popup window.

15. The computer storage medium of claim 12, the operations further comprising:
identifying one or more additional child frames that are displayable in the parent frame that are contextually associated with the child frame,
wherein providing for display the popup window further comprises preventing obstruction of the one or more additional child frames from display within the GUI by the popup window.

16. A system of one or more computers configured to perform operations comprising:
identifying a child frame that is displayable in a parent frame, the child frame associated with an application that is executing within the parent frame;
identifying a function for providing a popup window;
adding the function to the child frame;
calling, by the child frame, the function through the parent frame; and
in response to the calling, providing for display the popup window in the parent frame.

17. The system of claim 16, wherein providing for display further comprises providing for display the popup window on a graphical user interface (GUI).

18. The system of claim 17, wherein providing for display the popup window further comprises obscuring the child frame from display within the GUI by the popup window.

19. The system of claim 17, wherein providing for display the popup window further comprises preventing obstruction of the child frame from display within the GUI by the popup window.

20. The system of claim 17, the operations further comprising:
identifying one or more additional child frames that are displayable in the parent frame that are contextually associated with the child frame,
wherein providing for display the popup window further comprises preventing obstruction of the one or more additional child frames from display within the GUI by the popup window.
